(19) United States
(12) Patent Application Publication
(10) Pub. No.: US 2007/0009291 A1
(43) Pub. Date: Jan. 11, 2007

(54) Device and manufacturing method thereof

(76) Inventors: Yumiko Anzai, Ome (JP); Akemi Hirotsune, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/480,928

(22) Filed: Jul. 6, 2006

(30) Foreign Application Priority Data
Jul. 6, 2005 (JP) 2005-196968

(51) Int. Cl. G03G 15/20

(52) U.S. Cl. 399/324

(57) ABSTRACT

A process is simplified in a device in which desired materials are arranged in desired regions. After forming a film including a second material and a third material on a substrate having a first material on the surface, the second material and the third material are transferred utilizing the surface tension of the third material by using energy irradiation so that the second material comes on the first area of the surface of the substrate and the third material comes on the second area of the surface of the substrate. A fine device can be manufactured easily.

### CLAIM OF PRIORITY

The present application claims priority from Japanese application JP 2005-196968 filed on Jul. 6, 2005, the content of which is hereby incorporated by reference into this application.

### CO-PENDING APPLICATIONS

U.S. patent application No. 11/051143, No. 11/236786 and 11/319073 are co-pending applications of the present application. The disclosures of these co-pending applications are incorporated herein by cross-reference.

### FIELD OF THE INVENTION

The present invention relates to the aspect of a device having a plurality of regions which have different characteristics and a manufacturing method thereof.

### BACKGROUND OF THE INVENTION

A device is one utilizing nano-domains which have different chemical characteristics and physical characteristics created by giving an energy and, for instance, an electronic device such as an optical device and a magnetic device, a semiconductor device, and one utilizing nano-size uneven shapes.

Although a semiconductor and an optical disk are listed as an example of a device, a method utilizing an optical energy is known as a formation technique of these uneven patterns, in which a latent image is formed by irradiating a laser beam and an electron beam (EB) onto the resist coated on the substrate, and an uneven pattern is formed by developing the latent image and removing the part which has been or has not been irradiated. In both cases, finer patterns can be obtained by making the spot size of the laser beam and the EB smaller. Decrease in the spot size can be achieved by making the laser wavelength smaller and the numerical aperture (NA) of the objective lens larger. Besides, as a method utilizing thermal energy, a method for manufacturing an uneven pattern is described in Applied Physics Letters, Vol.85, No.4, 639-641 (2004), in which either a crystalline or an amorphous part is selectively removed.

Moreover, a magnetic recording medium is listed as another example of a device, and in this one a signal is created by the difference of the changing magnetic direction due to application of a magnetic force. Recently, a remarkable improvement in the areal recording density has been achieved by decreasing the size of the magnetic particles constituting the recording layer, by changing the material, and by improving the head processing, such as making a fine structure. Then, a discrete type magnetic recording medium is proposed in JP-A No. 97419/1997 as a candidate of a magnetic recording medium which is available with a further increase in the areal recording density, in which the recording layer is formed to be a predetermined uneven pattern and the recording area is divided by filling a non-magnetic material in the concave parts of the uneven pattern.

### SUMMARY OF THE INVENTION

In any technique described above, the manufacturing process for a device is complicated and it requires much expense in time and effort. Thus, it has been difficult to manufacture a device which is able to be manufactured easily and in a short time.

According to the present invention, the above-mentioned problems can be solved. A device includes a substrate having a first material over the surface, a second material formed over the first region of the substrate, and a third material having a different surface energy and surface curvature from said second material. The second material and said third material have different chemical and physical characteristics, the surface energy or the surface curvature of the third material are larger than those of the second material, and the region formed of the third material contains the second material in a range of less than 20%.

The composition change and shape change are created by giving optical or thermal energy to a functional layer formed to be a structure where the second material and the third material coexist or contact each other on the substrate having the first material thereon. In a word, the functional material B to be the second material and the functional material C to be the third material, which coexist in the functional layer and have different surface energies, are partially melted, resulting in the elements becoming easy-to-move. In this state, a material having greater surface energy moves to make the surface area smaller and a material having smaller surface energy works not to prevent this motion, so that areas having different chemical and physical characteristics can be formed. Or, the same effect can be obtained in the crystallization process of a material which is crystallized by receiving optical and thermal energy, in which it works such that extra material is eliminated, and the elimination is performed smoothly without disturbing the crystallization process, and it works so as to separate the material from the crystallized material, thereby, the composition flows in the functional layer so as to gather according to each functional material, and a desired material can be formed in a desired region. The preferable relationship of the surface energy is material 2< material 3. The amount limited to be less than 20% indicates that the material 2 is included in the material 3 as a result of the separation and flow, and it is also evidence of phase segregation.

Specifically, in the region formed of the third material, the second material remains in the vicinity of the first material which is a base layer, so that the content of the second material often increases toward the base layer side in the film thickness direction. Since it is a result of phase segregation having occurred, the content is less than 20%.

Even if it is not separated in each material, whatever part of the composition flows to make a different composition creates the difference of the optical, thermal, and magnetic characteristics, so that it is possible to identify the signal (recording mark) and others. The major component of the functional material B is only included in the region of the functional material C with a high surface energy and the content of the functional material B is different between the surface side and the side contacting the substrate. The content of the functional material B is greater at the side contacting the substrate. A change in the composition becomes easier if there is some trigger such as a fine unevenness or thermal fluctuations at the surface of the substrate and the surface of the base layer contacting the functional layer. For instance, if there is unevenness at the surface of the substrate, the functional material B and the functional material C in the functional layer are easily separated to the concave part and the convex parts. Moreover, when a region having a different surface energy, such as a wetting property, is provided to the base layer, the material flow between the functional material B and the functional material C occurs easily.

Moreover, if only the material formed in the desired region is left or removed by utilizing the difference of the characteristic created by the difference in the composition, for instance, the differences in the chemical reaction and the adhesion, the change of shape and the chemical or physical characteristics of the material can be utilized effectively. As a method for removing another material, dry etching, such as reactive ion etching, and wet etching are performed, and clarification is also carried out by sublimation or oxidation by applying a heat treatment at high-temperatures. Clarification is an especially effective means in the multi-layer structure in an optical disk.

Moreover, since a natural material flow is used which is created in a material having high surface energy by delivering to it optical or thermal energy, the shape of the formed region has a curvature.

In a device utilizing the chemical or physical characteristics of the formed region, it is important that the operating temperature is less than the melting point. If it is heated up higher than the melting point, the desired shape formed further continues to transform and the composition changes, resulting in it being impossible to obtain desired characteristics.

As explained above, in a device according to the present invention, by delivering thermal or optical energy to a functional layer formed on a substrate a desired material can be manufactured easily and in a short time in a desired region without going through a conventional complicated process. Moreover, as a result of phase segregation of the material B and the material C, a fine device structure can be obtained.

### BRIEF DESCRIPTION OF THE DRAWINGS

FIG. 1A is a cross-sectional drawing illustrating a device in the present invention;

FIG. 1B is a cross-sectional drawing illustrating a device in the present invention;

FIG. 1C is a cross-sectional drawing illustrating a device in the present invention;

FIG. 1D is a cross-sectional drawing illustrating a device in the present invention;

FIG. lE is a cross-sectional drawing illustrating a device in the present invention;

FIG. 1F is a cross-sectional drawing illustrating a device in the present invention;

FIG. 1G is a cross-sectional drawing illustrating a device in the present invention;

FIG. 1H is a cross-sectional drawing illustrating a device in the present invention;

FIG. 1I is a cross-sectional drawing illustrating a device in the present invention;

FIG. 1J is a cross-sectional drawing illustrating a device in the present invention;

FIG. 1K is a cross-sectional drawing illustrating a device in the present invention;

FIG. 1L is a cross-sectional drawing illustrating a device of a comparison;

FIG. 2 is a cross-sectional drawing illustrating a device in the first embodiment of the present invention;

FIG. 3 is a cross-sectional drawing illustrating a manufacturing method of a device in the first embodiment of the present invention;

FIG. 4A is a plane drawing illustrating a pattern formed in the present invention;

FIG. 4B is a plane drawing illustrating a pattern formed in the present invention;

FIG. 4C is a plane drawing illustrating a pattern formed in the present invention;

FIG. 4D is a plane drawing illustrating a pattern formed in the present invention;

FIG. 5 is a cross-sectional drawing illustrating a manufacturing method of a device in the second embodiment of the present invention;

FIG. 6 is a cross-sectional drawing illustrating a manufacturing method of a device in the third embodiment of the present invention;

FIG. 7 is a cross-sectional drawing illustrating a manufacturing method of a device in the fourth embodiment of the present invention;

FIG. 8 is a cross-sectional drawing illustrating a manufacturing method of a device in the fifth embodiment of the present invention;

FIG. 9 is a cross-sectional drawing illustrating a manufacturing method of a device in the sixth embodiment of the present invention;

FIG. 10 is a cross-sectional drawing illustrating a manufacturing method of a device in the eighth embodiment of the present invention;

FIG. 11A is a cross-sectional drawing illustrating a manufacturing method of a device in the ninth embodiment of the present invention;

FIG. 11B is a cross-sectional drawing illustrating a manufacturing method of a device in the ninth embodiment of the present invention;

FIG. 12A is a cross-sectional drawing illustrating a manufacturing method of a device in the tenth embodiment of the present invention;

FIG. 12B is a plane drawing of the wiring formed; and

FIG. 13 is a cross-sectional drawing illustrating a manufacturing method of a device in the tenth embodiment of the present invention.

### DETAILED DESCRIPTION OF THE PREFERRED EMBODIMENTS

Hereinafter, the present invention will be explained referring to the embodiments. A formed functional layer is melted by irradiation of optical or thermal energy. Therefore, a distribution of composition can be created within the functional layer by utilizing the differences in the surface energy between the functional material B and the functional material C in the formed functional layer as well as the difference in the surface energy of the base layer A in contacting with the functional layer.

As a device, the functional layer may be formed by allowing functional materials having different surface energies to coexist in the layer or by making a laminated structure. Therefore, the composition distribution in the fine regions can be changed by using optical or thermal energy. Moreover, in the case of a laminated structure, different characteristics can be created in the lamination direction only in the desired region by selecting a region in the plane direction where the composition is changed. Because there is a difference in the surface energies between the base layer A and the functional material B and the functional material C in the functional layer, they mix with each other in the laminated functional layer by delivering optical or thermal energy irradiation locally, and the regions having different characteristics can be obtained by changing the composition locally. In the case when either the functional material B or the functional material C is formed, the shape and the composition did not change even if energy is delivered. The important point is that the functional material B and the functional material C coexist in the same layer or are connected to each other in the structure. The surface energies between the functional material B and the functional material C are preferably different, and the preferable relationship of the surface energies is that the surface energy of the functional material B is smaller than that of the functional material C. The surface energy of the base layer may be smaller or larger than those of the functional materials B and C, or be some intermediate value. However, a composition distribution can be created in the functional layer by irradiating energy if it does not melt at the heat-treatment temperature. (Combination of functional materials B and C)

According to the investigation of the functional materials B and C by using SiO₂, Al₂O₃, Si, and Pt for the functional material A and changing the functional materials B and C, Ge—Sb—Te, Ge—Te, Ge—Bi—Te, In—Sb—Te, Sb, Ge—Bi—Sb—Te, Ge—Sb—Te—O, and Ge—Sb—Te—N were preferable as B, and Au, Ag, Cu, Pt, Pd, Ni, Ir, Rh, Co, Os, Ru, Fe, Re, Mn, W, Mo, Cr, Ta, Nb, V, Hf, Zr, Ti, Zn, Al, and Si were preferable as C. As mentioned above, it was preferable that the surface energy of C be twice or more as large as the surface energy of B.

Ge—Sb—Te is separated uniformly in the functional material B, so that it is preferable because a pattern with low noise can be formed. It is preferable because Ge—Bi—Te has a high crystallization velocity after melting, and the reading speed thereof can be increased. Ge-Te does not have good sensitivity during reading, but it is preferable since the contrast is large. Sb is preferable because it has a large rate of change while melting and a large SNR. In—Sb—Te and Ge—Bi—Sb—Te are preferable because they have low melting points and excellent sensitivity during reading. Ge—Sb—Te—O and Ge—Sb—Te—N are preferable because they have excellent storage stability.

Among the functional materials C, Au, Ag, Cu, Ni, Ir, Rh, Co, Os, and Ru were preferable since they segregated even when the irradiation energy was low. Au is preferable because it has low noise. Ag and Co are more preferable because they have a function for promoting the crystallization of the functional material B. Cu and Ni are more preferable because they have strong adhesion strength with the base layer and the protection layer. In the functional material C, although it is necessary that the irradiation energy for Pt and Pd be higher, they are stable after segregation, resulting in the durability being excellent. Pt is more preferable because it is possible further to make small marks and spaces with a diameter of 10 to 30 nm. Fe, Re, Mn, W, Mo, Cr, Ta, Nb, V, Hf, Zr, Ti, Zn, Al, and Si are preferable compared with a noble metal such as Au because their material costs are inexpensive. W, Mo, Cr, and Ta are preferable because they are hard materials and film deformation hardly occurs in the solvent while the functional material B is melted and solidified over and over again after the segregation. Among these materials Zn, Al, and Si are preferable because they are even less expensive and easy to handle. Fe, Re, Zr, Ti, V, and Hf are preferable because the signal change between the molten state and the non-molten state of the functional material increases and the SNR while reading can be made larger, since optical characteristics with the functional material B are close to the non-molten state after the segregation.

(Functional Material A)

Herein, results shown in Table 2 were obtained by investigating whether the phase segregation occurs or not while changing functional materials A when Ge—Sb—Te and Ag were used for the functional material B and the functional material C, respectively. The surface tension γ₀ of the functional material B is 333 (mN/m) and the surface tension γ₀ of the functional material C is 903 (mN/m). Herein, the melting points listed in the table were either the melting points or the temperatures where the material becomes a glass state and the surface tension changes drastically.

TABLE 1

| | | | Relationship | |
|---|---|---|---|---|
| | | | of surface | |
| | Surface | | tensions γ₀ | |
| | tension | Melting | of functional | |
| Functional | of A γ₀ | point of | materials A, B, | Presence of |
| material A | (mN/m) | A (° C.) | and C (mN/m) | segregation |
| SiO₂ | 300 | 1550 | A < B < C | Segregated |
| Al₂O₃ | 570 | 2049 | B < A < C | Segregated |
| Cr₂O₃ | 600 | 2330 | B < A < C | Segregated |
| SnO₂ | 600? | 1127 | B < A < C | Segregated |
| Si | 865 | 1410 | B < C < A | Segregated |
| Pt | 1800 | 1769 | B < C < A | Segregated |
| ZnS—SiO₂ | 250 | 1550 | A < B < C | Segregated |
| Ta—O | 600 | 1872 | B < A < C | Segregated |
| Mixture glass | 300 | 570 | A < B < C | Segregated |
| Polycarbonate | 700-750 | 140 | B < C < A | Non-segregated |
| Sn | 544 | 232 | B < A < C | Non-segregated |

In the table, the composition of the mixed glass was SiO₂—Al₂O₃—Na₂O—MgO. According to the above-mentioned results, it is understood that segregation was possible even if the surface energy of the functional material A is larger or smaller than that of either B or C, or the value is an intermediate one lying between these values. Since the film reaches 420° C. or more due to the irradiation of energy, segregation did not occur in the case when a functional material A having a melting point lower than 420° C. was used. In other words, it was understood that it was not separated sufficiently in the case when the functional material A is melted by the irradiation of energy for the segregation.

(Substrate)

In this embodiment, a plastic substrate which has unevenness corresponding to the ROM pattern and a glass substrate on which pattern is transferred are used for a protection substrate. A substrate having unevenness is a substrate which has grooves deeper than the atomic size all over or a part of the substrate surface. The unevenness, such as pits or grooves, may be formed continuously to make a circle or divided along the way. The size may be different according to the location. Moreover, for the substrate, one composed of polycarbonate, polyolefine, or an ultraviolet light curing resin is used for a plastic substrate. Besides, a material which doesn't transmit light such as Si may be also used.

In this embodiment, although the substrate is manufactured by mass-production using an injection molding technique, a glass and Si may be directly carved by using an electron beam, and an etching technique using a mask may also be used.

The difference in the surface roughness described in the fourth embodiment may be created by pressing a hard material against a part of the surface to form flaws or by melting a part of the substrate which has a rough surface by using an energy beam to planarize the surface.

The surface chemical treatment described in the fifth embodiment may be carried out by using a nano-printing technique, or, after coating, it may be altered by using an energy beam or removed.

Next, when a relationship between the average film thickness Dt, which is the sum of the film thicknesses of the functional material C and the functional material B, and the minimum size Sm of the separated shape which can be formed, it has been understood that Z, which is the ratio of the surface energy of the functional material C and the surface energy of the functional material B, has the relationships shown in formula (1) and formula (2).
Dt*10 /z≦Sm formula (1)
Z≦4 formula (2)
Table 1 shows the results of combining some functional materials. Herein, the surface energy of each material was compared according to measurements of the surface tension (mN/m) . Therefore, in order to reduce the size of the separated shape it is understood that the average film thickness Dt only has to become so thin as to satisfy the relationship between formula (1) and formula (2) or the relationship between the formula (3) and formula (4) which follow. Moreover, since the average film thickness depends on the ratio of the surface energies of both functional materials, it is understood that it depends on the combination of the materials. For instance, in order to form 100 nm marks when Au is used for the functional material C and Ge—Sb—Te is used for the functional material B, it was necessary to control the average film thickness to be 33 nm or less, and to be 17 nm to form 50 nm marks. However, when the surface energy ratio Z became four or more, since energy is working which controls motion in the direction of the plane, the same results could be obtained as in the case of Z being 4, as shown in Table 1. That is, the relationships between Dt and Sm are shown in formula (3) and formula (4).
Dt*10/4≦Sm formula (3)
Z>4 formula (4)

TABLE 2

| | Surface | | Surface | | | |
|---|---|---|---|---|---|---|
| | tension | | tension | Surface | Melting | |
| Functional | of C γ₀ | Functional | of B γ₀ | energy | point of | Dt (50) |
| material C | (mN/m) | material B | (mN/m) | ratio Z | A (° C.) | (nm) |
| Au | 1140 | Ge—Sb—Te | 333 | 3 | 33 | 17 |
| Ag | 903 | Ge—Sb—Te | 333 | 3 | 30 | 15 |
| Zn | 782 | Ge—Sb—Te | 333 | 2.3 | 24 | 12 |
| Ti | 1650 | Ge—Sb—Te | 333 | 5 | 37 | 20 |
| W | 2500 | Ge—Sb—Te | 333 | 8 | 39 | 21 |
| Cu | 1285 | Ge—Sb—Te | 333 | 4 | 36 | 19 |
| Pd | 1500 | Ge—Sb—Te | 333 | 5 | 37 | 20 |

| | | | | | |
|---|---|---|---|---|---|
| Sb | 367 | Ge—Sb—Te | 333 | 1.1 | Insufficient |
| | | | | | segregated |
| In | 556 | Ge—Sb—Te | 333 | 1.7 | Insufficient |
| | | | | | segregated |
| Sn | 544 | Ge—Sb—Te | 333 | 1.6 | Insufficient |
| | | | | | segregated |
| Bi | 378 | Ge—Sb—Te | 333 | 1.1 | Insufficient |
| | | | | | segregated |

Moreover, in the case when the surface energy ratio is less than 2, segregation is not adequate, so that the functional material C contained 30 to 40 percent of the functional material B. If weak energy is irradiated for a long time, the segregation situation is improved a little.

Since the difference in the surface energy of each material is important in the present invention, materials should be selected from the viewpoint only of their suitability as a combination and it is not intended to be limited to the described examples. There is a suitable range for the processing temperature according to the structure when the composition change is made to take place. It differs according to whether a plastic substrate is used or a glass plate and Si substrate are used, and according to the end-point temperature while being used as a device. For instance, in the case of using a plastic substrate, selecting a material is difficult because the process temperature reaches 100° C. in order to heat up the whole substrate, but it is usable if focused energy from a laser beam is utilized. In this case, the whole substrate is not heated up since the energy heats up only the functional layer, so that the influence of thermal deformation of the plastic substrate is small. However, it is preferable that the composition transformation temperature (material flow temperature) be not too high and that the melting point of the functional material C be as high as 1000° C. as a guideline. For instance, in the case when Ge—Sb—Te is used for the functional material B, the preferable functional material C is Au, Ag, or Cu, etc. In the case when a glass substrate and a Si substrate are used, it is possible to heat-treat the whole substrate and a high temperature processing is possible, resulting in an extension of the range of materials.

The transformation where the composition flows happens more easily when there is a trigger, such as fine unevenness or a thermal fluctuation, on the substrate surface and the base layer surface contacting the functional layer. For instance, when there is unevenness on the substrate surface, the composition of the functional layer is easily separated into the concave parts and the convex parts. Moreover, the composition change due to the flow of material hardly takes place by providing areas having different surface energies on the base layer, such as wetting properties. The material flow depends on the material and the temperature and is mostly complete in one to several minutes. In the case when materials having different compositions are formed in the concave parts and the convex parts in a conventional method, a thin film is formed after forming the uneven pattern shape by using a resist. Since the film over the resist film is removed together when the resist is removed, the pattern of material in the convex parts is formed. Then, if another material is further deposited thereon and the film only on the convex parts is removed by using a polishing technique, the different material can be made to exist in a desired pattern shape. In this conventional technique, two or three days are necessary in total. Thus, if a method of the present invention is used, a pattern can be formed in a desired area in a simple process without using expensive equipment.

Moreover, the content ratio of the functional material C relative to the functional material B, the film thickness, and the relationship between the shape of convex to be a trigger and the volume of the flowing material are controlled as conditions for forming the areas which have different characteristics by material flow, thereby, the surface curvature and the shape in each area can be arbitrarily formed after the material flow. For instance, in the case when the content of the functional material C is small, letting the material exist over the entire desired area becomes difficult, and, in the case when it is too much, it exists over a wider area than the desired area.

Furthermore, it is understood that there is a composition distribution in the area of the functional material C where the functional layer is partially melted and transferred. Since a material having high surface energy works to make the surface area smaller, it does not contain other elements and is almost composed of only major component. However, at the part in the vicinity of the base layer or the substrate surface, the molten functional material B exists to a minor extent. It has been understood that the composition of the functional material B coexists since it functions as an adhesive layer. As a result of composition analysis of this part by using EDX (S5200, produced by Hitachi), it has been understood that only 2 to 19 percent of Ge and Te is contained therein. Although error may be included in the measurements because these elements have detection peaks located close to the other components, there was a significant difference. However, this is not the range over which there are changes in the chemical and physical characteristics of this region, so that no problem occurred.

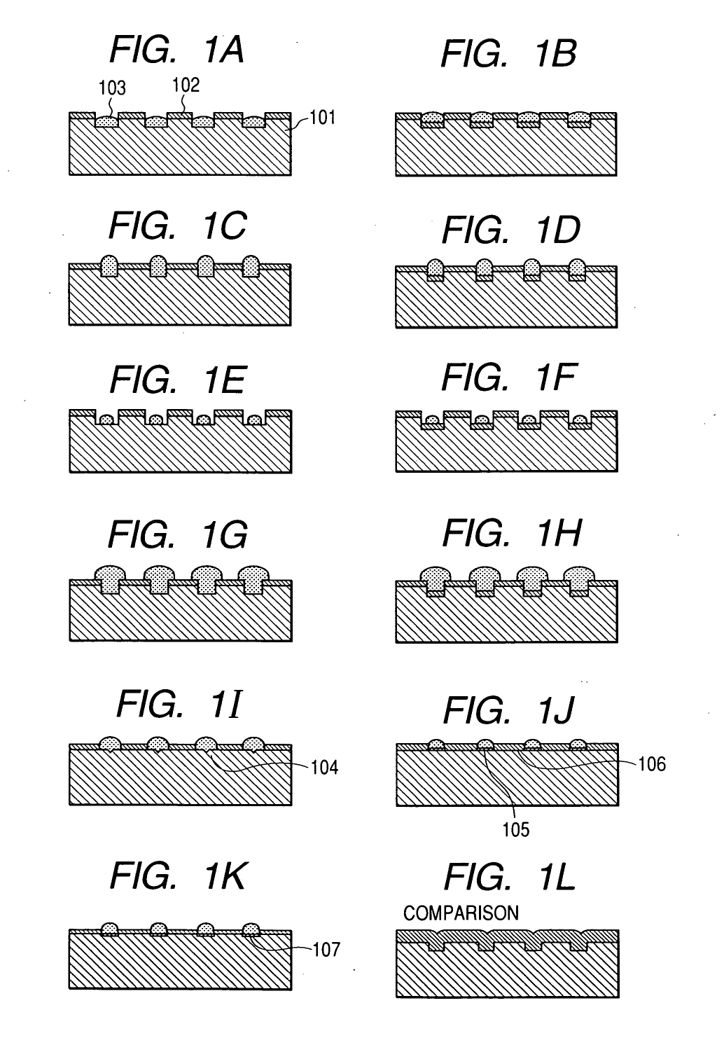

FIG. 1 is an example of the shape that may happen. FIG. 1A is an example illustrating a composition distribution of a functional layer, in which a substrate 101 has an uneven shape, a functional material B102 is formed on the convex parts, and a functional material C103 is formed in the concave parts. This is one formed by separating the material B and the material C by heating up after a mixture of the material B and the material C is formed on the uneven substrate 101.

FIG. 1B is another example illustrating a composition distribution of a functional layer which is formed in the case when heating conditions are different from FIG. 1A. This is one in which the material B and the material C are formed in the concave parts of the uneven substrate 101.

FIG. 1C is an example illustrating a composition distribution of a functional layer which is formed in the case when the uneven shape of the uneven substrate 101 is different or the content ratio is different from FIG. 1A. This is an example illustrating a shape of the material C formed in the concave parts when the width of the concave parts of the uneven substrate is narrow and when the content ratio of the material C is high.

FIG. 1D is an example illustrating a composition distribution of a functional layer which is formed in the case when the heating conditions are different from FIG. 1C. This is one in which the material B and the material C are formed in the concave parts of the uneven substrate 101. The feature of FIGS. 1C and 1D is that the material C comes up higher than the surface of the material B because of the large surface tension of the material C.

FIG. 1E is an example illustrating a composition distribution of a functional layer which is formed in the case when the uneven shape of the uneven substrate 101 is different or the content ratio is different from FIG. 1A. This is an example illustrating a shape of the material C formed in the concave parts when the width of the concave parts of the uneven substrate 101 is wide and when the content ratio of the material C is low.

FIG. 1F is an example illustrating a composition distribution of a functional layer which is formed in the case when the heating conditions are different from FIG. 1E. This is one in which the material B and the material C are formed in the concave parts of the uneven substrate 101. The feature of FIGS. 1E and F is that the material C caves in compared with the surface of the material B because of the shape of the substrate and the content of the material C.

FIG. 1G is an example illustrating a composition distribution of a functional layer which is formed in the case when the uneven shape of the uneven substrate 101 is different or the content ratio is different from FIG. 1A. This is an example illustrating a shape of the material C formed in the concave parts when the width of the concave parts of the uneven substrate 101 is narrow and when the content ratio of the material C is high.

FIG. 1H is an example illustrating a composition distribution of a functional layer which is formed in the case when the heating conditions are different from FIG. 1G. This is one in which the material B and the material C are formed in the concave parts of the uneven substrate 101. The feature of FIGS. 1G and 1H is that the material C comes up higher than the surface of the material B because of the large surface tension of the material C.

FIG. 1I is an example illustrating a composition distribution of a functional layer in the case when a functional material B and a functional material C are formed on a substrate 101 having a fine uneven shape 104 in the plane. This is one formed by segregation of the material B and the material C by taking the fine uneven shape as the trigger after a mixture of the material B and the material C is formed and heated up.

FIG. 1J is an example illustrating a composition distribution of a functional layer in the case when a functional material B and a functional material C are formed on a substrate having a difference in the surface energies 105 and 106 in the plane. This is one formed by segregation of the material B and the material C caused by a difference in the surface energies after a mixture of the material B and the material C is formed and heated up.

FIG. 1K is an example illustrating a composition distribution of a functional layer in the case when a functional material B and a functional material C are formed on a substrate 101 having surface roughness 107 in the plane. This is one formed by segregation of the material B and the material C caused by a difference in the surface roughness after a mixture of the material B and the material C is formed and heated up. The feature of FIG. 1K is that the material C comes up higher than the surface of the material B because of the large surface tension of the material C.

FIG. 1L is an example illustrating a film formed uniformly by using a conventional method. This is a film formed uniformly on a substrate having unevenness.

### FIRST EMBODIMENT

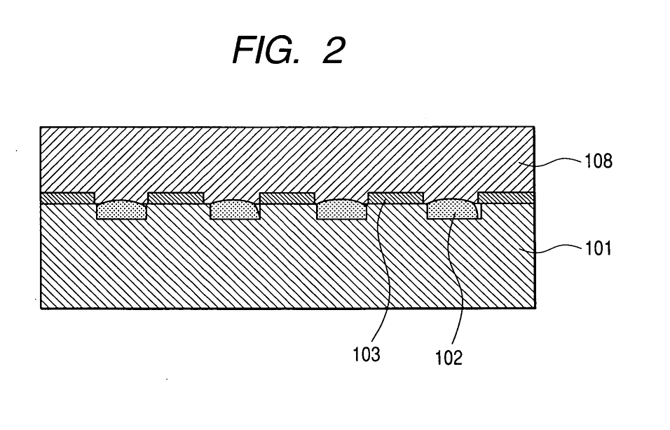

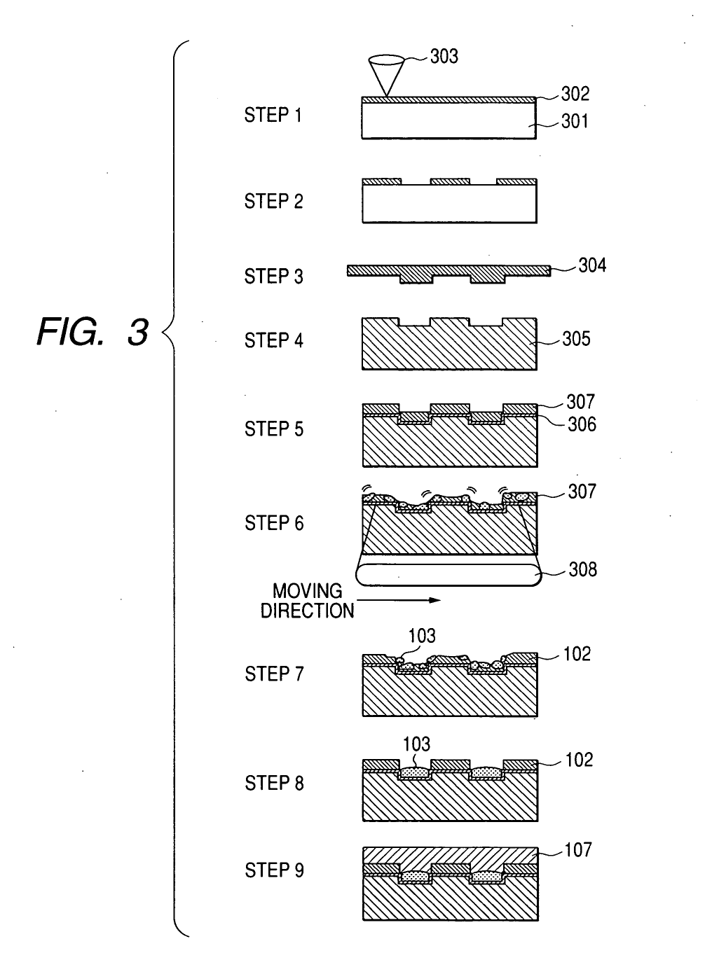

The first embodiment describes a manufacturing method of a ROM substrate using light. FIG. 2 is a cross-sectional structural drawing illustrating an example of a disk-shaped device in the present invention. This device has a structure, in which space parts mainly composed of the functional material C102 and mark parts mainly composed of the functional material B103 are segregated in the concave parts and the convex parts, respectively, on a substrate 101 having an uneven pattern on the surface, and the surface is covered with a protection substrate 108. FIG. 3 is an example of a method for forming the optical disk.

A pit pattern or line pattern shaped unevenly was formed by irradiating a focused laser beam 303 used for cutting onto the resist 302 coated on the glass substrate 301. Then, a Ni plate was formed by performing a plating technique on the surface, resulting in a Ni stamper 304 being fabricated. After that, a plastic substrate 305 having unevenness on the surface was fabricated by an injection molding technique using the Ni stamper as a molding die. A 10 nm thick SiO₂ is formed as a base layer 306 on the substrate by using a sputtering technique and a 25 nm thick functional layer 307 composed of Au—Ge—Sb—Te is laminated thereon to make a disk-shaped device. In this embodiment, the functional layer 307 consisted of two kinds of materials, the functional materials B and C, and Ge—Sb—Te was used for the functional material B 102 and Au for the functional material C which had a larger surface energy than the functional material B. Then, a laser beam 308 was irradiated onto the functional layer 307 as process 3. Herein, as shown in the direction of motion, irradiation was carried out moving the laser beam by rotating the disk-shaped device. The material constituting the functional layer is melted by this treatment as shown in process 8 and moves to the concave parts and the convex parts according to the amount of surface energy, resulting in the concentration distribution of the composition being altered. The region 103 mainly composed of Au was formed in the concave parts and the region 102 mainly composed of Ge—Sb—Te was formed on the convex parts. Process 7 shows the state of things from process 6 to process 8, and schematically shows the situation midway during segregation of the part mainly composed of Au and the part mainly composed of Ge—Sb—Te. The surface was protected by lamination with the protection substrate 107 after forming the recording marks. The laser beam irradiation device used to initialize the phase-change type rewritable disk could process in a short time since it was an oval type sheet beam with a width of 2 μm and a length of 50 μm. The functional layer changes even if it is partially irradiated by a focused laser beam with a small spot diameter. It is effective when the region to be transformed is limited to a narrow area.

Moreover, a similar state could be obtained when Pt and Cu were used for the functional material C of the functional layer. A film mainly composed of Pt and Cu, which had a curvature at the surface, was formed in the concave parts. Furthermore, the effect was confirmed by observing the composition distribution using SEM (scanning electron microscope) and nano-region TEM (transmission electron microscope), etc. Moreover, it is not necessary that the mother die used to transfer the uneven pattern be a Ni stamper if it is one which can be used for injection molding.

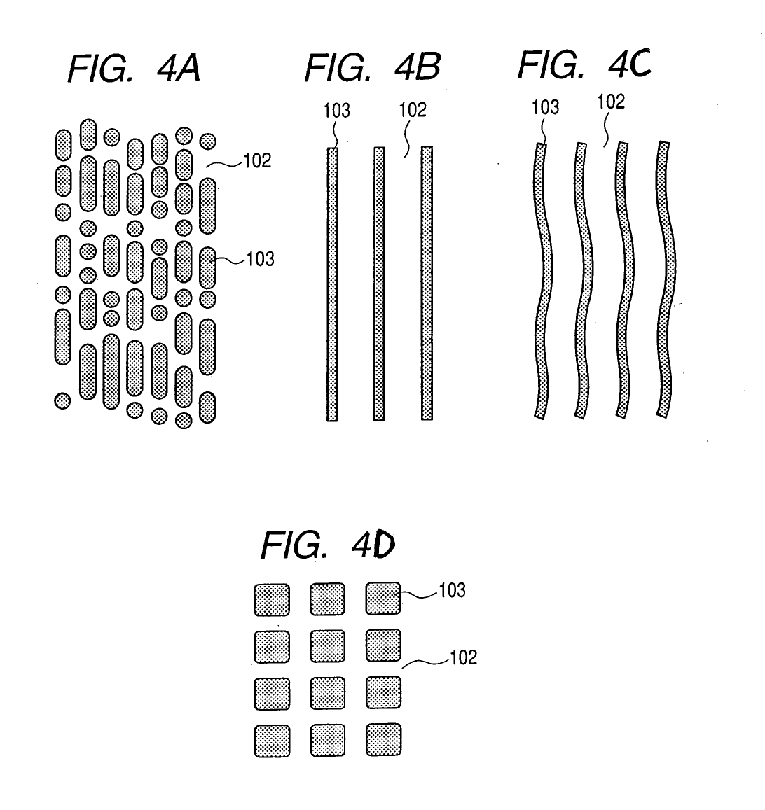

FIG. 4A is a layout drawing illustrating regions of the functional material B and the functional material C formed in a pit pattern shape which was fabricated by using the aforementioned manufacturing method. It consists of regions having different lengths. For instance, the area of the functional material C 103 corresponds to the pit pattern to be a ROM signal of the optical disk. FIG. 4B are drawings as seen from the top illustrating the functional material B and the functional material C formed in a line shape. FIG. 4C is a drawing as seen from the top illustrating the functional material B and the functional material C formed in another shape.

In the case of an optical disk on which a pit pattern is formed as shown in FIG. 3A, it is possible to make the material having high reflectance exist only in the pit pattern part. As a result, a high signal level can be easily obtained. Signals of a conventional optical disk, in which a reflection film was uniformly formed, used the differences in depth. A higher signal level could be obtained in a disk of this embodiment by using a material having low reflectance for the region except for the signal part and making the difference of the reflectance from the signal part.

Conventionally, since the device was manufactured through a plurality of processes, it has regularly taken several days to several weeks to manufacture a device. However, this device uses phase segregation and needs a short manufacturing time, several minutes to several tens of minutes, resulting in the formation of regions having different reflectance characteristics being obtained by using a simple manufacturing method.

Moreover, since a resist processing technology using conventional light energy uses only a part of the power in the center part of the beam for forming a fine shape, the influence of power deviation of the beam grows, resulting in the yield being decreased. However, such problems could be solved by using the manufacturing method in the present invention.

### SECOND EMBODIMENT

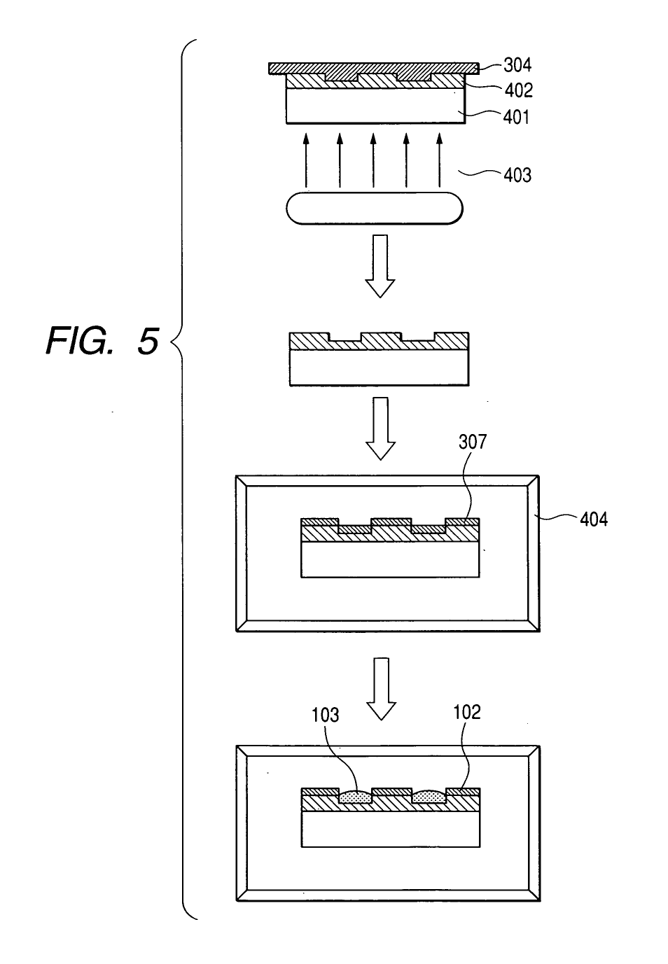

FIG. 5 is an example illustrating another method for manufacturing a substrate having an uneven shape. SOG (spin on glass) 402 is uniformly coated on a glass substrate 401, placed between a Ni stamper 304 and a glass plate and pressed, and peeled off at the interface with the Ni stamper by irradiating UV light 403, resulting in the pattern of the Ni stamper being transferred. The glass plate has excellent smoothness compared with a plastic substrate. Moreover, since SOG is mainly composed of SiO₂, it has excellent thermal resistance and heating becomes possible by using a baking furnace instead of the aforementioned sheet beam. Furthermore, heating by using a baking furnace brings excellent productive efficiency since a plurality of pieces can be treated simultaneously. A 13 nm thick functional layer 307 composed of Au—Ge—Sb—Te was deposited by using a sputtering technique on a glass plate with SOG which has been transferred from the Ni stamper. Then, heat treatment is performed in a baking furnace at 400° C. for one minute. The functional layer moved to the concave parts and the convex parts according to the amount of the surface energy by the heat treatment and the concentration distribution of the composition was changed. As a result, the functional material C 103 mainly composed of Au and the functional material B 102 mainly composed of Ge—Sb—Te are formed in the concave parts and on the convex parts, respectively. Although the movement of components is generated in the functional layer even if it was stopped and fixed during the heat treatment, the concentration distribution of the composition to the uneven parts was promptly completed by applying a small amount of external vibration. For instance, it was vibration, for instance up-and-down and right and left, etc. as well as rotation.

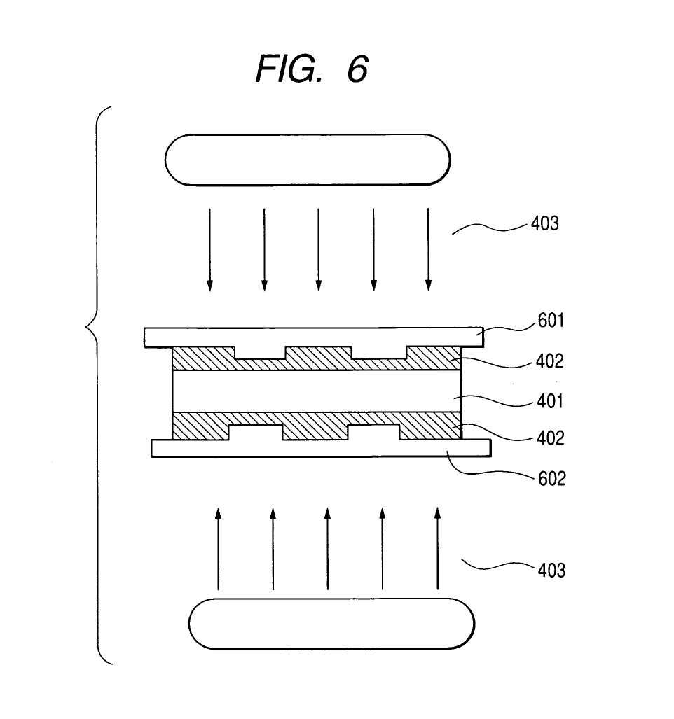

A similar state could be obtained even if Pt—Co or Cr—Co were used for the functional material C of the functional layer. A magnetic film mainly composed of Pt—Co or Cr—Co was formed in the concave parts and a non-magnetic material was formed on the surface of the convex parts. The composition distribution was confirmed by using SEM and nano-region TEM. The change of the functional layer was the same as the first embodiment. Third embodiment Another method for manufacturing a substrate having an uneven shape will be described. In the case when SOG is used for the transfer the same as the second embodiment, a quartz stamper 601 was also useable in lieu of the Ni stamper. FIG. 6 shows a part different from the second embodiment. If two pieces of clear quartz stampers 601 and 602 are used, pattern formation onto the both sides of the substrate can be carried out by transferring once, so that a high density device can be manufactured in a short time. In the quartz stamper, the concave part was formed on the quartz plate by coating a resist on the quartz plate, exposing it by a focused laser beam to be a desired size (pit pattern or line pattern), and performing RIE (reactive ion etching) after developing. A quartz stamper having unevenness with a desired depth was fabricated by removing the resist after RIE treatment. It is possible to make a plurality of Ni stampers by using this quartz stamper as an original plate. In the case when a quartz stamper is used for a mother die, a Si substrate may be used in lieu of a glass plate on which an uneven pattern is transferred. It only has to be irradiated by UV light and either of the stamper or the substrate on which an uneven pattern is transferred only has to be transparent. Next, SOG (spin on glass) 402 is uniformly coated on a glass substrate 401, the SOG 402 is uniformly placed between the quartz stampers 601 and 602 and the glass plate 401 and pressed, and peeled off at the interface with the quartz stamper by irradiating UV light, resulting in a glass substrate on which an unevenness is transferred being obtained. As shown in FIG. 5, a 13 nm thick functional layer 307 composed of Au—Ge—Sb—Te was deposited on this substrate by using a sputtering technique. Then, a heat treatment was applied at 400° C. for one minute. Melting occurred in the functional layer due to the heat treatment and moved to the concave parts and the convex parts according to the amount of the surface energy, resulting in the concentration distribution of the composition being changed. As a result, regions were obtained where the compositions were different in the concave portion and the convex part. As a result, the functional layers could be formed on both surfaces of the substrate. It can be applied to a ROM having recording layers on both surfaces.

Heating through the substrate by using the sheet beam was impossible in the case of using a Si substrate because light could not transmit. However, similar to a glass substrate, a Si substrate makes it possible to process a plurality of substrates at once since heat treatment using a baking furnace was possible, and similar results could be obtained at a price lower than that of a glass substrate. The transformation of the functional layer caused by heat-treatment in the baking furnace was the same as the first and second embodiments.

### FOURTH EMBODIMENT

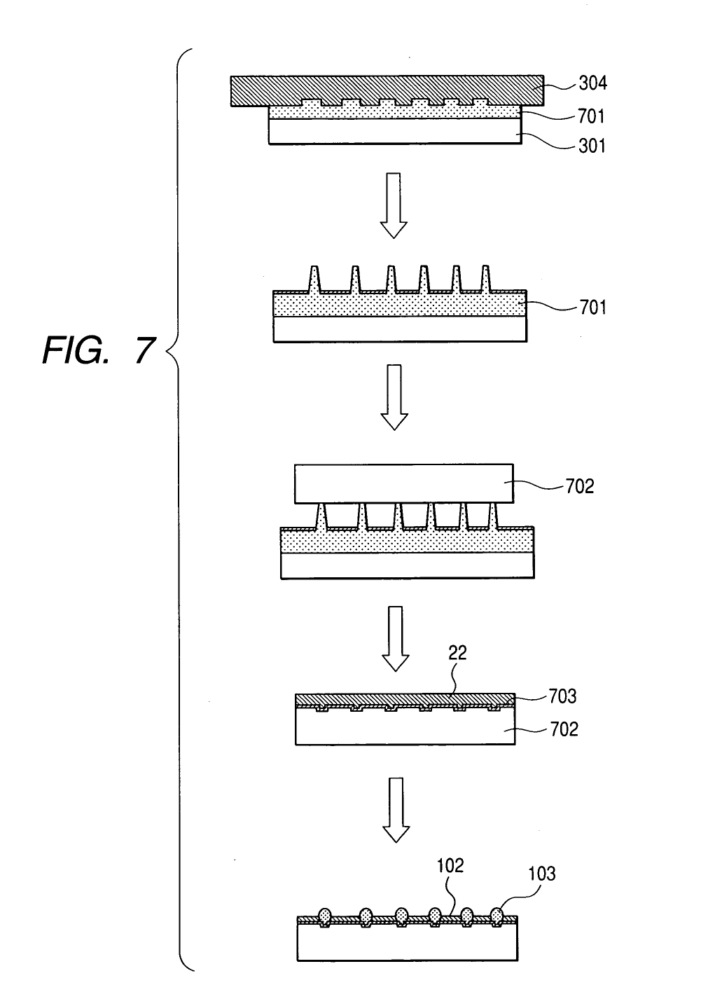

Another method for manufacturing a substrate having an uneven shape will be described. Even if it was a small trigger, it was effective for promoting the composition change in the functional layer. FIG. 7 is one example of a manufacturing method. First, an unevenly formed Ni stamper 304 was fabricated. The light for irradiating the resist is assumed to be an electron beam and a pit pattern with a diameter of 50 nm or a line pattern with a width of 50 nm was formed unevenly. As an example, a PMMA resin 701 was spin-coated on the glass substrate 301 and, after heating the whole substrate at 110° C., the Ni stamper was pressed onto the resin thin film in a vacuum atmosphere. The holding pressure was controlled to be 2 MPa. Then, while keeping the resin soft, the Ni stamper was peeled off from the substrate uniformly to elongate the resin and stretch in both the parallel and the vertical direction. As a result, the PMMA resin in the concave parts of the Ni stamper was elongated in a direction vertical to the substrate and needle-shaped convex parts were formed taller than the depth of the concave parts of the Ni stamper. For instance, when the size of the pits of the Ni stamper was 70 nm in depth and 120 nm in diameter, convex parts with a height of 300 nm and a diameter of 30 nm could be obtained, which were taller and smaller than the pit size of the Ni stamper. Next, a substrate 702 having minute unevenness was fabricated by using a PMMA resin substrate having a pattern with a sharp tip as a master substrate. Pressing the master substrate having the aforementioned needle-shaped convex parts onto the surface of the polycarbonate plate 702 or the surface of the base layer to touch only the tip thereof, slight concave-shaped dimples (flaws) were formed on the surface of the polycarbonate plate 702 or the surface of the base layer. Herein, a concave-shaped dimple can be easily formed when the polycarbonate substrate is kept in the temperature range from 70° C. to 135° C. On this substrate, a 10 nm thick SiO₂ was formed as the base layer 703 and a 25 nm thick Au—Ge—Sb—Te was formed as the functional layer 22 by using a sputtering technique. Then, while rotating this disk, the functional layer is heated up by irradiating a sheet beam of the initialization apparatus, each material in the functional layer being melted and moved to the concave parts and the convex parts according to the amount of surface energy, resulting in the concentration distribution of the composition being changed. As a result, the composition and the shape changed as shown in FIG. 1I, and, as shown in the bottom of FIG. 7, Ge—Sb—Te 102 being the material B and A 103 being the material B were segregated from each other. This result indicated that Au could move even if there is slight concave-shaped dimple. Herein, if the unevenness is 10 nm or more, the material B and the material C will phase segregate. Therefore, it is understood that the composition distribution can be obtained arbitrarily even if the unevenness is quite small in the case when there is a difference in the surface energy. In the same way, the point-shaped pattern tip is pressed to the surface of the Au—Ge—Sb—Te film 22 directly sputtered onto the polycarbonate substrate to form slight concave-shaped dimples (flaws) onto the film itself. That is, in this case, even if a SiO₂ film is not formed as the base layer, the composition change in the functional layer by heating occurred in the same way starting with this dimple (flaw).

As shown in FIG. 4A, the areas of the functional material B and the functional material C were formed in the shape of pit patterns. They consisted of areas with different lengths. For instance, 103 is a pit which will be a ROM signal of the optical disk.

The composition region formed on a slight dimple was fabricated to have a thicker film thickness than the other region. Au as the functional material 103 formed to be a pit shape like FIG. 4A for a signal of the optical disk exists in a shape with a curvature on the surface. When it is read as a signal, it becomes a pit with no shoulder and with a gentle curve compared with a conventional rectangular pit as shown in FIG. 4L, resulting in a signal level being obtained with few noise elements.

### FIFTH EMBODIMENT

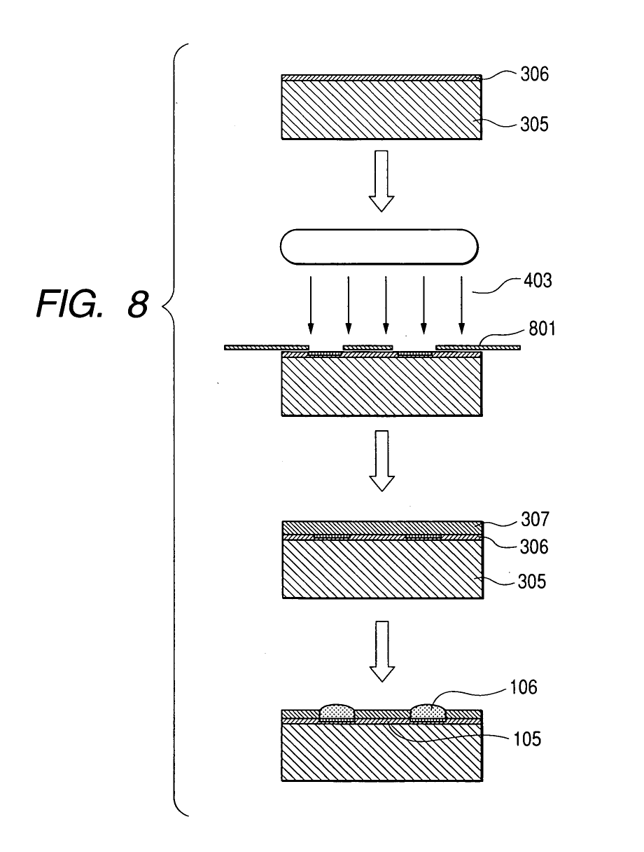

Another method for promoting the composition change in the functional layer will be explained. As one technique for promoting the composition change in the functional layer, utilizing the difference in the surface state of the substrate surface or the base layer was effective. FIG. 8 is a manufacturing method thereof. The composition changes according to the influence of the surface state of the base layer when the functional layer changes by receiving the energy from light and heat. A TiO₂ film was used as a base layer. A 30 nm thick TiO₂ was deposited as a base layer 306 on a substrate 305 by using a sputtering technique and UV light 403 was irradiated onto this film surface through a mask 801 where a desired pattern has been formed. Only the part of the TiO₂ film on which UV light was irradiated reacts and the surface energy decreases by modification. Therefore, utilizing this surface energy, the composition change of the functional layer can be promoted. After irradiation of UV light, 25 nm thick Au—Ge—Sb—Te was deposited on the TiO₂ as a functional layer 307. Then, a laser beam was irradiated onto the substrate while rotating. According to the heat-treatment by using a laser beam, the functional layer was separated into the region 106 mainly composed of Au and the region 105 mainly composed of Ge—Sb—Te as shown in FIG. 1G.

Moreover, regions of the functional material B and the functional material C as shown in FIG. 4A, 4B, and 4C could be formed. Since this manufacturing method depends on the shape of the cover mask, it only has to form the cover mask according to the desired size. UV light is used in the case when a relatively large pattern is formed and a light source such as an EB may be used to obtain a narrow pattern. When a cover mask is used, it only has to control ahead of time the positions of the cover mask and the substrate securely and it is not necessary for controlling each pattern. Therefore, there is an advantage beyond the productivity in that one only has to irradiate or scan the light which becomes a light source onto the entire surface of the required area and that a desired material can be formed in a desired region without a vacuum process.

Moreover, as a method for manufacturing a region having different surface states, a sputtering process using a cover mask is available. When a material with a different surface energy from the functional layer was sputtered onto the substrate, a base layer was only formed on the part where the material passed through the mask. In the same manner, a 25 nm thick Au—Ge—Sb—Te was formed on this substrate and a laser beam is irradiated while rotation the substrate. According to the heat-treatment by the laser beam, the functional layer was formed so as to segregate into a region mainly composed of Au and a region mainly composed of Ge—Sb—Te as shown in FIG. 1J.

### SIXTH EMBODIMENT

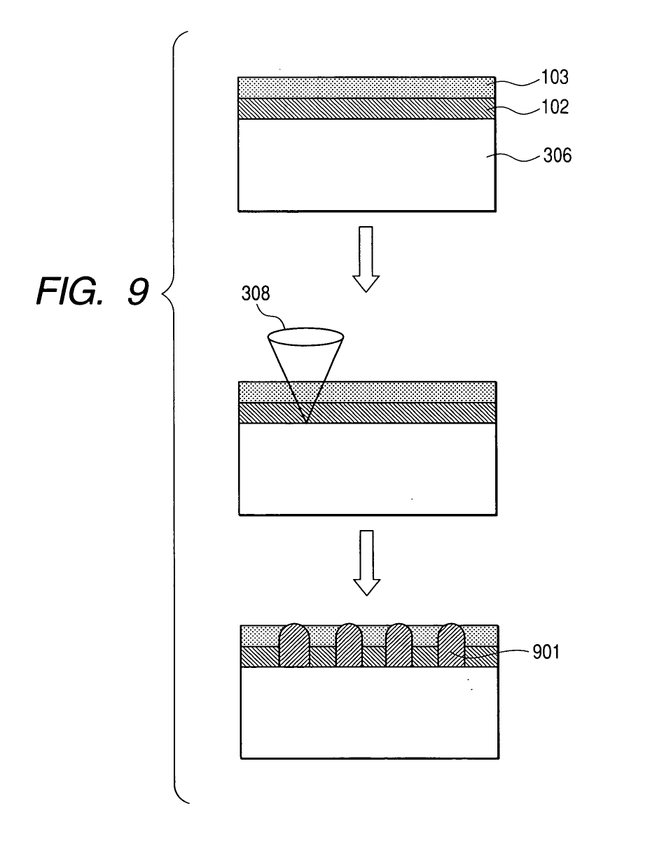

FIG. 9 shows an example of the application to a magnetic disk in the case when the functional layer is deposited divided in two layers. A 20 nm thick Cr alloy, a 10 nm thick Ge—Sb—Te, and a 20 nm thick Co—Cr—Pt alloy were stacked as a base layer 306, as a functional material B 102, and as a functional material C 103, respectively, on a glass substrate. Then, while rotating the substrate, the layer is heated from the inner circumference to outer circumference with a feed pitch of 200 nm by using a focused laser beam 308 with a wavelength of about 400 nm. There was a problem with the process time; since it was not sheet beam but narrow region energy irradiation by using a focused laser beam, the composition change could be created in a small area with a line width of 50 nm. A result was obtained such that the region 901 to which the laser beam was irradiated had different magnetic characteristics from the other region. This region 901 is composed of Ge—Sb—Te+Co—Cr—Pt. In this case, the region which was not heated is a magnetic recording area and the heated part where the magnetic characteristics were changed will be a region which limits broadening of the magnetic field of the recording mark and prevents the side-fringe and the crosstalk caused by the broadening of the magnetic field. A part of the functional layer was melted due to heating by the laser beam and the compositions were mixed with each other, resulting in the characteristics being changed. The roughness change caused by this process hardly occurred, so that stable head floating could occur. Since this method makes it possible to fabricate a desired device only by using laser beam irradiation, the manufacturing process is simple and the manufacturing time can be made much shorter compared with a manufacturing process for a conventional discrete medium. For instance, the process for forming the roughness on the substrate becomes unnecessary.

### SEVENTH EMBODIMENT

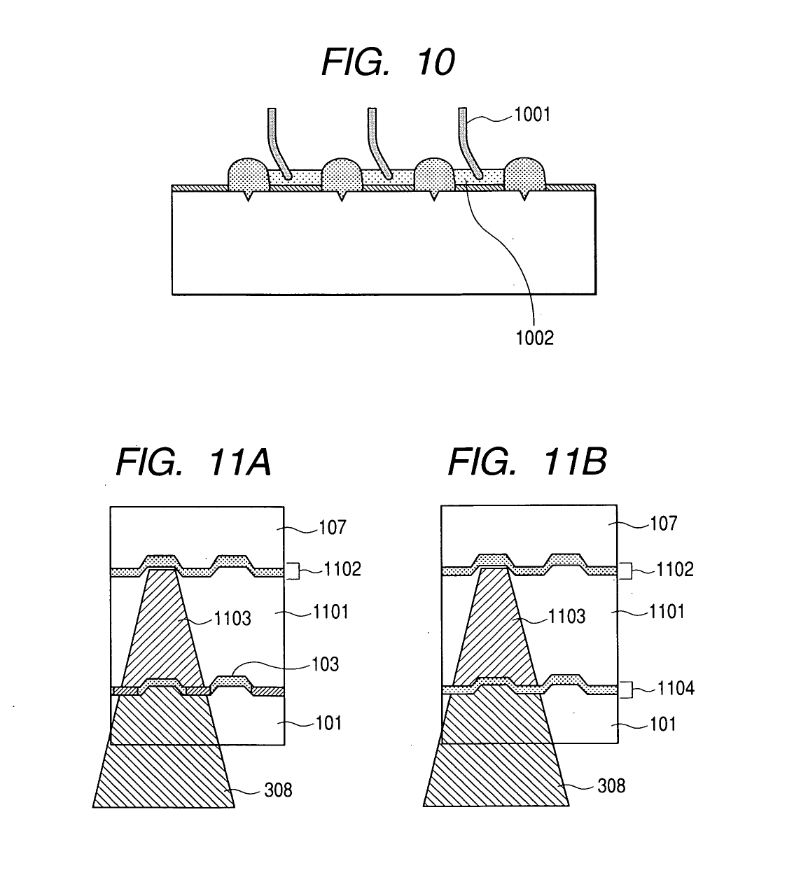

The film thickness of the region formed on small dimples like the fourth embodiment is easily made thicker compared with the area formed on other region. If the content ratio of the material with high surface energy is made greater, the region with curvature exists in a convex condition compared with the other region as shown in FIG. 10. The surfaces of the functional material B 102, the functional material C 103, and the base layer 101 have different surface energies and the wetting properties against liquid are different. For instance, coating a liquid thereon and using different surface energies, a liquid body can be made to exist only on one area. And, it can be made to exist only on the pit shaped area or a line shaped area. Moreover, the functional material B 102 in a concave part may be removed. Even in this case, using surface energies of the base layer and the substrate which are different from that of the functional material C 103, it can be made the liquid exist only on one region.

For instance, an example where it is used for a bio-chip tray will be explained. Probes of nucleotide arrangement or proteins, etc. are formed on the concave parts 1002 in FIG. 10. At this time, probes 1001 which are different types from each other are formed in each region of the concave parts. These probes may be bonded with the substrate by either covalent bonds or ionic bonds. Then, the sample to be examined (specimen), such as blood etc., is dropped on a substrate on which the probe is provided. Herein, since the surface wetting properties of the functional material B and the functional material C are different, the specimen 1002 is rejected by the convex parts and segregates to the concave parts by dropping the liquid specimen on the chip-plate and slightly moving up-and-down and right-and-left, resulting in it being distributed. In this way, a desired examination can be carried out. The sample is segregated neatly in each concave part and they are never contaminated among the concave parts, resulting in the reaction being detected with great accuracy. Moreover, since the probe itself has hydrophilic, hydrophobic, and charged properties, grouping and ordering the probes may be possible. At the same time, differences in the wetting properties of the aforementioned trays can be used for grouping of biomolecules with hydrophilic, hydrophobic, and charge properties.

### EIGHTH EMBODIMENT

In the manufacturing method shown in the first embodiment, one of the regions composed of functional material B and the functional material C formed in a pit pattern for an optical disk was removed or made transparent by utilizing dry or wet etching techniques and sublimation and oxidation effects by the heat-treatment, resulting in a state being created where a laser beam is not absorbed in the region except for the pattern. For instance, when the functional material B is composed of Ge—Sb—Te, it can be removed by using alkaline wet etching, and, in the case of utilizing the oxidation effect, the functional material B can be made transparent caused by increasing permeability by the heat treatment when it is composed of IrOₓ, Ag alloy-ZnS, and TaN, etc. As a pattern, regions shown in FIGS. 4B and 4C can be formed in ways other than the pit pattern of FIG. 4A. Then, a protection film is formed so as not to move the formed region. Moreover, by repeating the process for forming the pit shape, the process for heating the functional layer and removing one area, and the process for forming the protection layer, a multi-layer optical disk was formed in which the functional material exists only on the pattern region and on the other region is a film permeable to a laser beam. Due to the manufacture of multilayer disks in such a manner absorption of the laser beam in each of the foreground layers where the laser beam passes through in order to read the deeper layers can be decreased, which has been a previous problem. Since the difference in the reflectivity is large between the signal part and the other region, a high signal level could be obtained. FIGS. 11A and 11B are drawings comparing a double-layered structure utilizing the present invention and a conventional double-layered structure. FIG. 11A shows the structure composed of the functional material C 103, the intermediate layer 1101, and the second layer 1102, and the protection substrate 107 formed on the substrate 101. The signal is read by irradiating the laser beam 308. Even in the case when the second layer is read, attenuation of a quantity of light of the laser beam 1103 passing through the intermediate layer is small because the region except for the region 103 which will become a signal is transparent. On the other hand, in the conventional structure in FIG. 11B, the quantity of light 1103 attenuated due to the absorption of the laser beam is great in the first layer 1104.

The spacer layer (a layer for forming the pit pattern) which exists for segregation of the layers may not have a constant thickness in order to prevent the influence of multi-reflections.

### NINTH EMBODIMENT

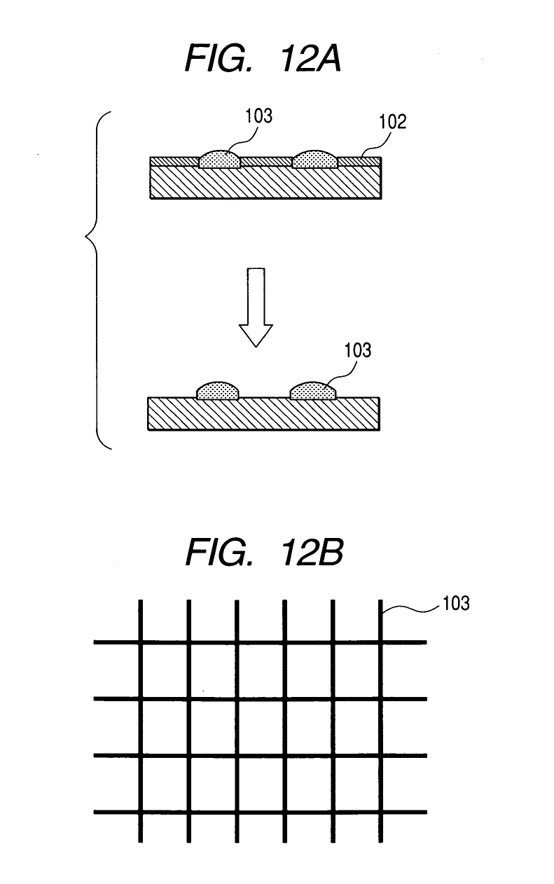

FIG. 12 is an example of an application to a manufacturing method of wiring in a semiconductor device. First of all, slight unevenness was formed on the wiring pattern which was desired to be formed beforehand on the Si substrate. Then, a Cu—Ge—Sb—Te film is deposited and heated in a baking furnace at 400° C. for one minute. As a result, region where a composition mainly composed of Cu is congregated is formed in the concave part taking the slight concavity as a trigger, and it is separated from the region mainly composed of the Ge—Sb—Te. Then, Ge—Sb—Te is removed and only Cu remained as shown in FIG. 12A. The Cu area to become wiring includes Ge—Sb—Te at the region contacting the substrate because Ge—Sb—Te was melted and functions as an adhesive layer. Additionally, it also has the effect of preventing separation and wire breakage caused by Cu migration. FIG. 12B is a plane drawing of the wiring formed.

Conventionally, since the wiring is manufactured through a plurality of processes, that is, it is regularly manufactured through a plurality of processes such as resist processing, pattern exposure, partial resist removal, depth processing by dry etching, wiring material film deposition, and polishing, it has taken several days. However, since phase segregation is utilized in the case of this manufacturing method, formation of a region having different electrical characteristics could be obtained by a simple manufacturing method such that the processing time takes several minutes since the material can be easily formed in the wiring area only by heat treatment, although the pattern formation is necessary as a trigger ahead of time.

### TENTH EMBODIMENT

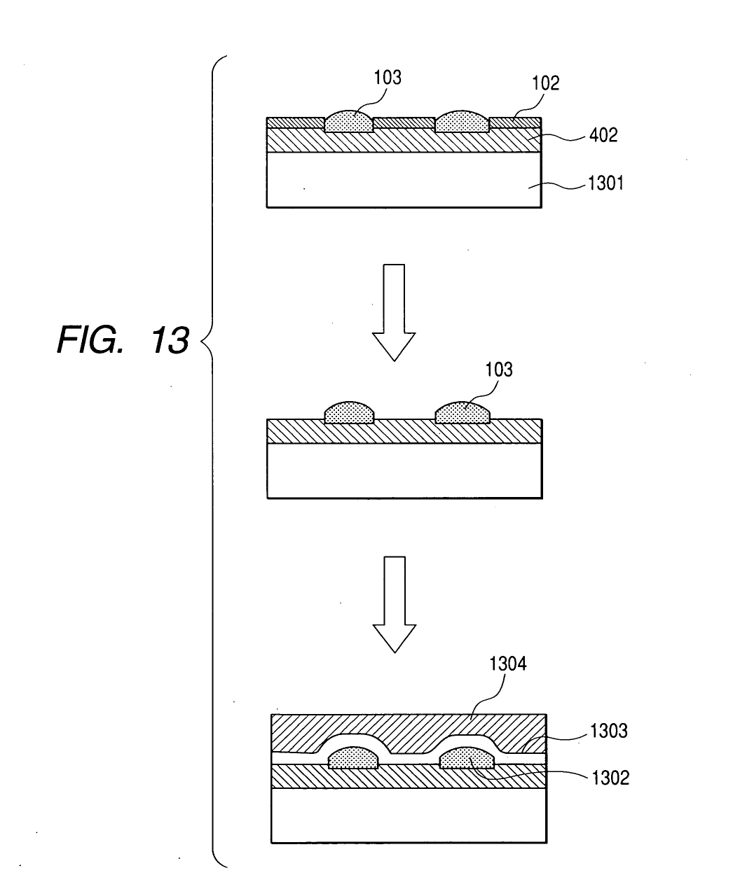

FIG. 13 is an example of an application to a manufacturing method of a luminescence element. An uneven pattern composed of SOG 402 was formed on a transparent substrate 1301 by using the manufacturing method shown in the second embodiment. A film in which Ge—Sb—Te and ZnO coexist as the functional material B and the functional material C, respectively, was deposited thereon by using a sputtering technique, and the heat treatment was performed in a baking furnace at 400° C. for one minute. There was segregation into the regions of functional material B 102 and the functional material C 103 by the heat treatment, and then the functional material B, Ge—Sb—Te, which was one of these materials, was removed by etching. ZnO which was not removed and left thereon, becomes the transparent electrode 1302. After that, an organic luminescent layer 1303 composed of an alkylate complex and a metallic electrode 1304 composed of Ag—Mg were deposited. The extraction efficiency of the light, which was emitted by applying a voltage between the transparent electrode and the metallic electrode, became high due to a prism phenomenon caused by the transparent electrode having a curvature shape. A conventional method has required expensive equipment and processing days in order to fabricate an electrode having a curvature shape because complicated processes, such as manufacturing the mother die, pattern transfer, and film deposition, were necessary. However, by using the method in this embodiment, obtaining a transparent electrode having a curvature shape could be achieved by using a simple manufacturing method in a short time.

What is claimed is:

1. A device comprising:
a substrate having a first material over the surface,
a second material formed over the first region of said substrate,
a third material formed over the second region of said substrate and having a different surface energy and surface curvature from said second material,
wherein said second material and said third material have different chemical and physical characteristics,
the surface energy or the surface curvature of the third material being larger than those of the second material,
a region formed of the third material contains the second material in a range of less than 20%, and it is used at temperatures lower than the melting points of said second material and third material.

2. A device according to claim 1, wherein
the content of the second material is different between the side contacting said substrate and the surface side having a curvature in a region formed of said third material, and
the side contacting said substrate has a greater content of the second material.

3. A device according to claim 1, wherein
said substrate is uneven, and
said third material is formed in said concave parts and said second material is formed on said convex parts.

4. A device according to claim 1, wherein the region of said second material has a laminated structure of a first film and a second film.

5. A device according to claim 1, wherein
said second material is used as a first information recording layer,
a second information recording layer is provided over said second material through an intermediate layer, and
an optical beam is irradiated thereto through said first information recording layer while reading said second information recording layer

6. A device according to claim 1, wherein
the film thickness of said third material is greater than the film thickness of said second material.

7. A device according to claim 1, wherein
said device is either an optical device, a magnetic recording medium, a semiconductor device, a luminescence device, or a biochip.

8. A device comprising:
a substrate having a first material over the surface,
a second material formed over the first region of said substrate,
a third material formed over the second region of said substrate and having a different surface energy and surface curvature from said second material,
wherein said second material and said third material have different chemical and physical characteristics,
the surface energy or the surface curvature of the third material being larger then those of the second material,
the content of said second material in the region formed of the third material becoming greater toward said substrate side, and it is used at temperatures lower than the melting points of said second material and third material.

9. A device according to claim 8, wherein
the content of said second material in the region formed of said third material is less than 20%.

10. A method for manufacturing a device comprising the steps of:
forming a film including a second material and a third material over a substrate having a first material on the surface thereof,
transferring said second material and said third material by irradiating an energy such that said second material and said third material come over the first region of the surface of said substrate and over the second region of the surface of said substrate, respectively,
wherein it is used at temperatures lower than the melting points of said second material and third material.

11. A method for manufacturing a device according to claim 10, wherein
said energy is optical or thermal energy.

12. A method for manufacturing a device according to claim 10, wherein
said substrate is one on which unevenness was formed by pressing nano-pillars, and
said third material is formed in the concave parts of said substrate and said second material is formed on the convex parts thereof.

13. A method for manufacturing a device according to claim 10, wherein
a film containing said second material and said third material are formed after said first material is modified by selectively irradiating an energy to said first region of said first material.
